(19) United States
(12) Patent Application Publication
(10) Pub. No.: US 2007/0177223 A1
(43) Pub. Date: Aug. 2, 2007

(54) Optical system scanning unit and an image forming apparatus having the same

(75) Inventor: Jung-kwon Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/599,295

(22) Filed: Nov. 15, 2006

(30) Foreign Application Priority Data
Jan. 27, 2006 (KR) 2006-08810

(51) Int. Cl. H04N 1/04

(52) U.S. Cl. 358/474

(57) ABSTRACT

An optical system unit includes a light source to project a light onto a document, a plurality of reflecting mirrors to receive the light reflected from the document and forming a plurality of optical paths, a lens to form an image by focusing the light reflected from the reflecting mirrors at a focusing position thereof, and a reading unit disposed at the focusing position of the lens, wherein at least seven optical paths are formed between the document and the lens by the plurality of reflecting mirrors, and a first reflecting mirror that receives the light from the document along a first optical path is disposed lower than the other reflecting mirrors.

### CROSS-REFERENCE TO RELATED APPLICATIONS

This application claims the benefit under 35 U.S.C. §119(a) of Korean Patent Application No. 2006-8810, filed Jan. 27, 2006, in the Korean Intellectual Property Office, the entire contents of which are incorporated herein by reference.

### BACKGROUND OF THE INVENTION

1. Field of the Invention

The present general inventive concept relates to an optical system and an image reading apparatus having the same.

2. Description of the Related Art

Generally, image reading apparatuses, such as a scanner, a facsimile, a copier, and a multifunction apparatus, read an image from a document, convert the read image to an electric signal, and output the signal.

The image reading apparatus includes an optical system unit. In the optical system unit, when a light is projected from a light source onto an original document positioned on a document tray, the light reflected from the original document is reflected by a plurality of reflecting mirrors. After passing through a lens, an image of the reflected light is finally formed on an image sensor, such as a charge-coupled device (CCD). As the above-structured optical system unit moves in a sub-scanning direction, image information of the original document is read.

The optical system unit of the image reading apparatus includes a plurality of optical paths formed by the plurality of reflecting mirrors between the light source and the image sensor. Arrangement of the optical paths is an influential factor that determines a performance of the image reading apparatus.

The performance of the image reading apparatus can be improved when a total length of the optical paths is increased, since a vignetting phenomenon is weakened. However, the increase in the total length of the optical paths for minimizing the vignetting phenomenon requires a greater number of reflecting mirrors, thereby increasing the manufacturing cost and size of the apparatus. This increase in the number of reflecting mirrors deteriorates utility of the image reading apparatus.

### SUMMARY OF THE INVENTION

The present general inventive concept provides an optical unit capable of improving a reading performance and having a compact size, and an image reading apparatus having the same.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing an optical system unit including a light source to project a light onto a document, a plurality of reflecting mirrors to receive the light reflected from the document and to form a plurality of optical paths, a lens to form an image by focusing the light reflected from the reflecting mirrors at a focusing position thereof, and a reading unit disposed at the focusing position of the lens. At least seven optical paths are formed between the document and the lens by the plurality of reflecting mirrors, and a first reflecting mirror that receives the light from the document along a first optical path is disposed lower than the other reflecting mirrors.

The number of reflecting mirrors may be at least four.

At least one of the reflecting mirrors may be able to reflect the light at least twice.

The plurality of reflecting mirrors may be disposed so that a sum of an incidence angle and a reflection angle of the light forms an acute angle with respect to perpendicular axes thereof.

A total length of the optical paths formed by the document and the reflecting mirrors may not be less than 250 mm.

The plurality of reflecting mirrors may include the first reflecting mirror to directly receive the light along the first optical path formed between the first reflecting mirror and the document, a second reflecting mirror to receive the light along a second optical path formed by the first reflecting mirror, a third reflecting mirror to receive the light along a third optical path formed by the second reflecting mirror, and a fourth reflecting mirror to receive the light along a fourth optical path formed by the third reflecting mirror and to form a fifth optical path. The light may be reflected by the fourth reflecting mirror along the fifth optical path back to the third reflecting mirror and may be reflected again by the third reflecting mirror, thereby forming a sixth optical path. The light reflected along the sixth optical path may be incident back on the fourth reflecting mirror and may be reflected again, thereby forming a seventh optical path. The first optical path may be perpendicular to the document.

The third and the fourth reflecting mirrors may be arranged in a manner such that reflecting surfaces thereof are substantially parallel with each other.

The plurality of reflecting mirrors may include the first reflecting mirror to receive the light along the first optical path formed between the first reflecting mirror and the document, a second reflecting mirror to directly receive the light along a second optical path formed by the first reflecting mirror, a third reflecting mirror to receive the light along a third optical path formed by the second reflecting mirror, a fourth reflecting mirror to receive the light along a fourth optical path formed by the third reflecting mirror and to reflect the light back to the third reflecting mirror along a fifth path, and a fifth reflecting mirror disposed near the fourth reflecting mirror to receive the light reflected back to the third reflecting mirror by the fourth reflecting mirror along a sixth optical path and to form a seventh optical path by reflecting the light received along the sixth optical path. The first optical path may be perpendicular to the document.

A reflecting surface of the third reflecting mirror may be disposed substantially parallel with reflecting surfaces of the fourth and the fifth reflecting mirrors.

The foregoing and/or other aspects of the present general inventive concept may also be achieved by providing an image reading apparatus including a document tray mounted to a main body of the apparatus to position a document thereon, and an optical system unit having a light source, a plurality of reflecting mirrors, a lens, and a reading unit in communication with one another to read an image from the document. At least seven optical paths are formed between the document and the lens by the plurality of reflecting mirrors, and a first reflecting mirror receives the light along a first optical path, which is perpendicular to the document and is disposed lower than the other reflecting mirrors.

The foregoing and/or other aspects of the present general inventive concept may also be achieved by providing an image reading apparatus, including a frame having a window on which a document is positioned, a light source disposed adjacent to the window to emit light toward the document, a mirror arrangement having a plurality of mirrors to fold a light beam reflected by the document such that the light beam is reflected by a selected one of the mirrors at least two times, and a reading unit disposed adjacent to the mirror arrangement to read the folded light beam.

The foregoing and/or other aspects of the present general inventive concept may also be achieved by providing an image reading apparatus, including a frame having an input portion on which a document is positioned and an output portion, a light source disposed adjacent to the input portion to emit light to the document such that a light beam is reflected from the document into the input portion of the frame along an input axis, and a plurality of reflectors arranged about the input axis of the light beam to fold the light beam and to reflect the light beam toward the output portion along an output axis that is perpendicular to the input axis.

The foregoing and/or other aspects of the present general inventive concept may also be achieved by providing an image reading apparatus, including a frame having an entrance portion to receive a light beam containing image information along an entrance axis and an exit portion through which the light beam is output along an exit axis, and a first reflector disposed in the frame at an end of the entrance axis that is opposite to the entrance portion of the frame, at least one second reflector disposed on a first side of the entrance axis, at least one third reflector disposed on a second side of the entrance axis to reflect the light beam received from the first reflector to and from the at least one second reflector and to the exit portion of the frame, and a reading unit disposed at the exit portion to read the light beam received from the at least one third reflector.

The foregoing and/or other aspects of the present general inventive concept may also be achieved by providing an image reading apparatus, including a frame having a window on which a document is positioned, a light source disposed adjacent to the window to emit light toward the document such that a light beam is reflected into the frame along an axis, and a mirror arrangement having a plurality of mirrors to fold a light beam reflected by the document, the arrangement including a first mirror disposed on a first side of the axis and a plurality of second mirrors disposed on a second side of the axis in a concave arrangement, and a reading unit disposed adjacent to the mirror arrangement to read the folded light beam.

The foregoing and/or other aspects of the present general inventive concept may also be achieved by providing an optical system, including an optical frame, a first window formed on a first portion of the optical frame, a second window formed on a second portion of the optical frame, a first mirror to receive a first beam from the first window along a first optical path of the beam, a first group of one or more mirrors disposed on a first side of the first optical path to reflect the first beam and one or more beams received from a second side of the first optical path toward the second side of the first optical path, a second group of one or more optical mirrors disposed on the second side of the first optical path to reflect the beams received from the first side toward the first side of the first optical path, and a lens disposed in the optical frame to direct one of the beams reflected from the first group of one or more mirrors toward the second window.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates an optical system unit usable in an image reading apparatus, according to an embodiment of the present general inventive concept; and

FIG. 2 illustrates an optical system unit usable in an image reading apparatus, according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

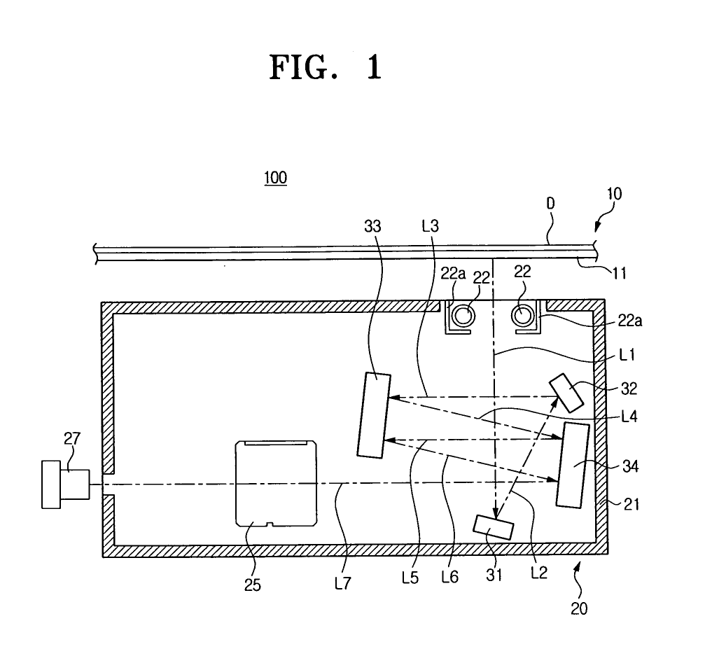

FIG. 1 illustrates an optical system unit 20 usable in an image reading apparatus 100, according to an embodiment of the present general inventive concept.

As illustrated in FIG. 1, the image reading apparatus 100 includes a main body (not shown), a document tray 10 where a document D is placed, and the optical system unit 20 to read an image from the document D.

The document tray 10 is supported by an upper part of the main body and has a transparent scan window 11. The document D is placed on the scan window 11.

The optical system unit 20 includes an optical frame 21, a light source 22 (i.e., at least one light source) to project a light onto the document D, a plurality of reflecting mirrors 31, 32, 33 and 34 to receive the light reflected from the document D and thereby forming optical paths L1 to L7, a lens 25 to focus the reflected light at a focusing position, and a reading unit 27 arranged at the focusing position of the lens 25.

The optical frame 21 is disposed under the document tray 10 and can be moved by a predetermined driving unit (not shown). The light source 22 is mounted at an upper part of the optical frame 21. A reflector 22a may be further provided near the light source 22 to reflect the light projected from the light source 22 toward the document D.

The light source 22 may be implemented by a fluorescent lamp or a halogen lamp. The light source 22 projects the light to the document D directly or through the reflector 22a, thereby illuminating the document D.

The document D and the plurality of reflecting mirrors 31, 32, 33 and 34 are arranged so as to form at least seven optical paths L1 to L7 between the document D and the reading unit 27.

The first reflecting mirror 31 is disposed so that the light reflected from the document D is incident along a first optical path L1 formed between the first reflecting mirror and the document D. The first optical path L1 may be perpendicular to the document D. The first reflecting mirror 31 forms a second optical path L2 to reflect the light received along the first optical path L1.

The light reflected along the second optical path L2 formed by the first reflecting mirror 31 is incident on the second reflecting mirror 32, thereby forming a third optical path L3. The light reflected along the third optical path L3 is incident on the third reflecting mirror 33, thereby forming a fourth optical path L4. The light reflected along the fourth optical path L4 is incident to the fourth reflecting mirror 34, thereby forming a fifth optical path L5. The light reflected along the fifth optical path L5 is incident back to the third reflecting mirror 33, thereby forming a sixth optical path L6. The light reflected along the sixth optical path L6 is incident back on the fourth reflecting mirror 34, thereby forming a seventh optical path L7 toward the lens 25 and the reading unit 27.

The first reflecting mirror 31 may be disposed lower than the second, third, and fourth reflecting mirrors 32, 33, and 34. In addition, since the third and the fourth reflecting mirrors 33 and 34 are configured to reflect the light at least twice, the optical frame 21 and the image reading apparatus 100 can be made to have a compact size.

More particularly, since the third and the fourth reflecting mirrors 33 and 34 are configured to reflect the light at least twice, the at least seven optical paths L1 to L7 can be formed from the document D to the lens 25. Accordingly, a sufficient number of optical paths can be formed for effectively preventing the vignetting phenomenon.

The third and the fourth reflecting mirrors 33 and 34 may be arranged in a manner in which reflecting surfaces thereof are substantially parallel with each other.

The lens 25 is arranged substantially parallel with the document D and focuses the light incident through the seventh optical path L7. In other words, the seventh optical path L7 and an axis of the lens 25 can be arranged parallel to a surface of the document D.

The reading unit 27 includes an image sensor, such as a charge-coupled device and is disposed at a position to receive the light focused by the lens 25. The reading unit 27 may be installed in the optical frame 21 to move together with the optical system unit 20. It is possible that the reading unit 27 is disposed adjacent to an exit of the reflected beam (output from the lens 25) to receive the reflected beam. Accordingly, the reading unit 27 is stationary and the optical system unit 20 is movable with respect to the document tray 10. It is also possible that the document D is movable with respect to the optical system unit 20.

The plurality of reflecting mirrors 31 to 34 are disposed so that a sum of an incidence angle and a reflection angle of the light form an acute angle with respect to perpendicular axes of the reflecting mirrors 31 to 34, thereby preventing interference among the reflecting mirrors 31 to 34 and providing accurate incidence and reflection operations. For example, a sum of a first angle of the light incident along the first path L1 with respect to a perpendicular of the first reflecting mirror 31 and a second angle of the light reflected along the second path L2 with respect to the perpendicular of the first reflecting mirror 31 is between 0 and 90 degrees.

The first path L1 may be an entrance axis (or input axis) along which the light beam is received by the first reflecting mirror L1 through an entrance portion (or input portion) of the optical frame 21, and the seventh path L7 may be an exit axis (or output axis) along which the light beam is received by the reading unit 27 through an exit portion (or output portion) of the optical frame 21. The reflecting mirrors 31, 32, 33, and 34 may collectively be a mirror arrangement. The mirror arrangement may “fold” the light beam along the light paths L1 to L7. The reflecting mirrors 31, 32, 33, and 34 may be formed integrally or separate from one another.

In addition, a total length of the optical paths L1 to L7 from the document D to the lens 25 is not less than 250 mm, which is a minimum threshold capable of preventing the vignetting phenomenon.

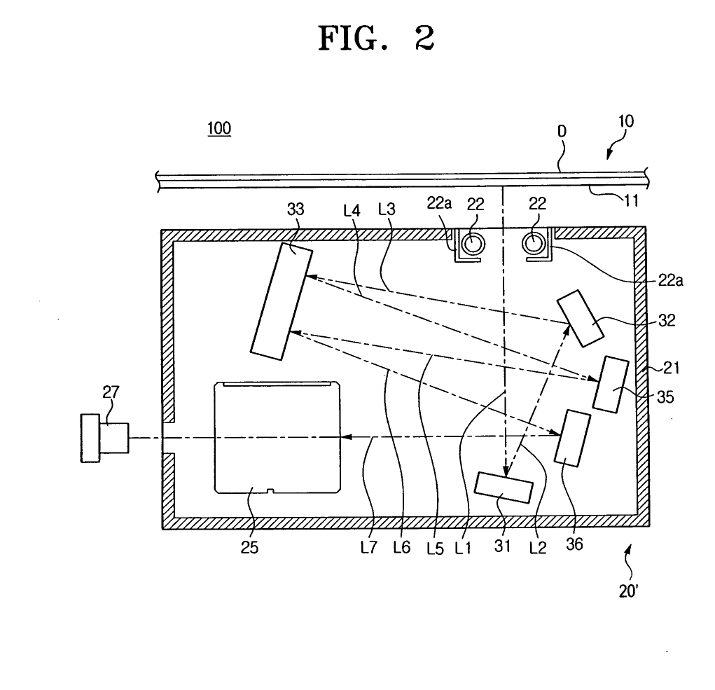

FIG. 2 illustrates an optical system unit 20′ of the image reading apparatus 100, according to another embodiment of the present general inventive concept. Some of the components of the embodiment of FIG. 2 are similar to components of the embodiment of FIG. 1 and are labeled and referred to accordingly. Additionally, since an overall structure and operation of the optical system unit 20′ of FIG. 2 is similar to that of the optical system unit 20 of FIG. 1, some detailed description thereof will not be provided.

As illustrated in FIG. 2, the optical system unit 20′ includes five or more reflecting mirrors arranged differently from the embodiment of FIG. 1, which includes four reflecting mirrors 31 to 34. In other words, in the present embodiment, one or both of the third and the fourth reflecting mirrors 33 and 34 may be replaced by two or more mirrors, thereby providing accuracy of an optical path and restraining interference among the reflecting mirrors.

In FIG. 2, the fourth reflecting mirror 34 of the embodiment of FIG. 1 is replaced by fourth and fifth reflecting mirrors 35 and 36. In other words, the present embodiment is provided with a larger number of reflecting mirrors 31, 32, 33, 35, and 36, thereby providing a longer and more accurate optical path. Furthermore, interference among optical paths L1, L2, L3, L4, L5, L6, and L7 formed among the reflecting mirrors 31, 32, 33, 35, and 36 can be prevented. The present embodiment may have seven or more optical paths L1 to L7. The reflecting mirrors 31, 32, 33, 35, and 36 may be a mirror arrangement, and the first, second, fourth, and fifth reflecting mirrors 31, 32, 35, and 36 may have a concave arrangement disposed at a first side of the entrance axis (i.e., the first path L1) while the third reflecting mirror 33′ is disposed at a second side of the entrance axis (i.e., the first path L1). Additionally, it should be understood that the optical paths L1 through L7 and the first, second, and third reflecting mirrors 31, 32, and 33 of the optical unit 20′ of FIG. 2 may be different from the optical paths L1 through L7 and the first, second, and third reflecting mirrors 31, 32, and 33 of the optical unit 20 of FIG. 1.

A reflecting surface of the third reflecting mirror 33′ may be disposed substantially parallel with reflecting surfaces of the fourth and the fifth reflecting mirrors 35 and 36.

According to the embodiments of the present general inventive concept, an image reading apparatus can be mage to have a more compact size and a reading performance thereof can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An optical system unit, comprising:
a light source to project a light onto a document;
a plurality of reflecting mirrors to receive the light reflected from the document and forming a plurality of optical paths;
a lens to form an image by focusing the light reflected from the reflecting mirrors at a focusing position thereof; and
a reading unit disposed at the focusing position of the lens,
wherein at least seven optical paths are formed between the document and the lens by the plurality of reflecting mirrors, and a first reflecting mirror that receives the light from the document along a first optical path is disposed lower than the other reflecting mirrors.

2. The optical system unit of claim 1, wherein the plurality of reflecting mirrors comprises at least four reflecting mirrors.

3. The optical system unit of claim 1, wherein the plurality of reflecting mirrors are disposed such that a sum of an incidence angle and a reflection angle of the light forms an acute angle with respect to perpendicular axes thereof.

4. The optical system unit of claim 1, wherein a total length of the optical paths formed by the document and the reflecting mirrors is not less than 250 mm.

5. The optical system unit of claim 2, wherein the plurality of reflecting mirrors comprises:
a first reflecting mirror to directly receive the light along the first optical path formed between the document and the first reflecting mirror;
a second reflecting mirror to receive the light along a second optical path formed by the first reflecting mirror;
a third reflecting mirror to receive the light along a third optical path formed by the second reflecting mirror; and
a fourth reflecting mirror to receive the light along a fourth optical path formed by the third reflecting mirror and to form a fifth optical path such that the light is reflected by the fourth reflecting mirror along the fifth optical path back to the third reflecting mirror and is reflected again by the third reflecting mirror, thereby forming a sixth optical path, and the light received along the sixth optical path is incident back on the fourth reflecting mirror and is reflected again, thereby forming a seventh optical path.

6. The optical system unit of claim 5, wherein the third and the fourth reflecting mirrors are arranged in a manner such that reflecting surfaces thereof are substantially parallel with each other.

7. The optical system unit of claim 2, wherein the plurality of reflecting mirrors comprises:
a first reflecting mirror to directly receive the light along the first optical path formed between the first reflecting mirror and the document;
a second reflecting mirror to receive the light along a second optical path formed by the first reflecting mirror;
a third reflecting mirror to receive the light along a third optical path formed by the second reflecting mirror;
a fourth reflecting mirror to receive the light along a fourth optical path formed by the third reflecting mirror and to reflect the light back to the third reflecting mirror along a fifth path; and
a fifth reflecting mirror disposed near the fourth reflecting mirror to receive the light reflected back to the third reflecting mirror by the fourth reflecting mirror along a sixth optical path, and to form a seventh optical path by reflecting the light received along the sixth optical path.

8. The optical system unit of claim 7, wherein a reflecting surface of the third reflecting mirror is disposed substantially parallel with reflecting surfaces of the fourth and the fifth reflecting mirrors.

9. An image reading apparatus, comprising:
a document tray mounted to a main body of the apparatus to position a document thereon; and
an optical system unit having a light source, a plurality of reflecting mirrors, a lens, and a reading unit in communication with one another to read an image from the document,
wherein at least seven optical paths are formed between the document and the lens by the plurality of reflecting mirrors, and a first reflecting mirror receives the light along a first optical path, which is perpendicular to the document and is disposed lower than the other reflecting mirrors.

10. The image reading apparatus of claim 9, the plurality of reflecting mirrors comprises at least four reflecting mirrors.

11. The image reading apparatus of claim 9, wherein the plurality of reflecting mirrors are disposed so that a sum of an incidence angle and a reflection angle of the light form an acute angle with respect to perpendicular axes thereof.

12. The image reading apparatus of claim 9, wherein a total length of the optical paths formed by the document and the reflecting mirrors is not less than 250 mm.

13. The image reading apparatus of claim 10, wherein the plurality of reflecting mirrors comprises:
a first reflecting mirror to directly receive the light along the first optical path formed between the document and the first reflecting mirror;
a second reflecting mirror to receive the light along a second optical path formed by the first reflecting mirror;
a third reflecting mirror to receive the light along a third optical path formed by the second reflecting mirror; and
a fourth reflecting mirror to receive the light along a fourth optical path formed by the third reflecting mirror and to form a fifth optical path such that the light is reflected by the fourth reflecting mirror along the fifth optical path back to the third reflecting mirror and is reflected again by the third reflecting mirror, thereby forming a sixth optical path, and the light received along the sixth optical path is incident back on the fourth reflecting mirror and is reflected again, thereby forming a seventh optical path.

14. The image reading apparatus of claim 13, wherein the third and the fourth reflecting mirrors are arranged in a manner such that reflecting surfaces thereof are substantially parallel with each other.

15. The image reading apparatus of claim 10, wherein the plurality of reflecting mirrors comprises:
a first reflecting mirror to directly receive the light along the first optical path formed between the document and the first reflecting mirror;
a second reflecting mirror to receive the light along a second optical path formed by the first reflecting mirror;
a third reflecting mirror to receive the light along a third optical path formed by the second reflecting mirror;
a fourth reflecting mirror to receive the light along a fourth optical path formed by the third reflecting mirror and to reflect the light back to the third reflecting mirror along a fifth path; and
a fifth reflecting mirror disposed near the fourth reflecting mirror to receive the light reflected back to the third reflecting mirror by the fourth reflecting mirror along a sixth optical path, and to form a seventh optical path by reflecting the light received along the sixth optical path.

16. The image reading apparatus of claim 15, wherein a reflecting surface of the third reflecting mirror is disposed substantially parallel with reflecting surfaces of the fourth and the fifth reflecting mirrors.

17. An image forming apparatus, comprising:
a frame having a window on which a document is positioned;
a light source disposed adjacent to the window to emit light toward the document;
a mirror arrangement having a plurality of mirrors to fold a light beam reflected by the document such that the light beam is reflected by a selected one of the mirrors at least two times; and
a reading unit disposed adjacent to the mirror arrangement to read the folded light beam.

18. An image forming apparatus, comprising:
a frame having an input portion on which a document is positioned and an output portion;
a light source disposed adjacent to the input portion to emit light to the document such that a light beam is reflected from the document into the input portion of the frame along an input axis; and
a plurality of reflectors arranged about the input axis of the light beam to fold the light beam and to reflect the light beam toward the output portion along an output axis that is perpendicular to the input axis.

19. The image forming apparatus of claim 18, wherein the light beam is reflected across the input axis at least five times.

20. The image forming apparatus of claim 18, wherein sum angles of incidence and reflection angles of the light beam with respect to each of the reflectors are acute angles.

21. An image reading apparatus, comprising:
a frame having an entrance portion to receive a light beam containing image information along an entrance axis and an exit portion through which the light beam is output along an exit axis; and
a first reflector disposed in the frame at an end of the entrance axis that is opposite to the entrance portion of the frame;
at least one second reflector disposed on a first side of the entrance axis;
at least one third reflector disposed on a second side of the entrance axis to reflect the light beam received from the first reflector to and from the at least one second reflector and to the exit portion of the frame; and
a reading unit disposed at the exit portion to read the light beam received from the at least one third reflector.

22. An image reading apparatus, comprising:
a frame having a window on which a document is positioned;
a light source disposed adjacent to the window to emit light toward the document such that a light beam is reflected into the frame along an axis; and
a mirror arrangement having a plurality of mirrors to fold a light beam reflected by the document, the arrangement including a first mirror disposed on a first side of the axis and a plurality of second mirrors disposed on a second side of the axis in a concave arrangement; and
a reading unit disposed adjacent to the mirror arrangement to read the folded light beam.

23. An optical system, comprising:
an optical frame;
a first window formed on a first portion of the optical frame;
a second window formed on a second portion of the optical frame;
a first mirror to receive a first beam from the first window along a first optical path of the beam;
a first group of one or more mirrors disposed on a first side of the first optical path to reflect the first beam and one or more beams received from a second side of the first optical path toward the second side of the first optical path;
a second group of one or more optical mirrors disposed on the second side of the first optical path to reflect the beams received from the first side toward the first side of the first optical path; and
a lens disposed in the optical frame to direct one of the beams reflected from the first group of one or more mirrors toward the second window.

24. The optical system of claim 23, wherein the beams reflected from the first side toward the second side by the first group of mirrors cross the first optical path.

25. The optical system of claim 24, wherein the beams reflected from the second side toward the first side by the second group of mirrors cross the first optical path and a second optical path of the beam received from the first mirror.

26. The optical system of claim 23, wherein the first group of mirrors comprises:
a second mirror to reflect the beam from the first mirror; and
a single monolithic mirror to reflect the beams from the second side.

27. The optical system of claim 23, wherein the second group of mirrors comprises a single monolithic mirror having a first mirror portion to reflect a portion of the beam and a second mirror portion to reflect another portion of the beam.

28. The optical system of claim 23, wherein the first group and second group are disposed between the first window and the first lens and opposite to each other with respect to the first optical path of the first beam.
